(19) United States
(12) Patent Application Publication
(10) Pub. No.: US 2005/0022391 A1
(43) Pub. Date: Feb. 3, 2005

(54) Trimmer starter and method

(76) Inventor: Leonard E. Heyman, Upper Marlboro, MD (US)

Correspondence Address: Leonard E. Heyman, 581 Hollingsworth Dr., Los Altos, CA, 94022, US

(21) Appl. No.: 10/629,142

(22) Filed: Jul. 30, 2003

(51) Int. Cl. B26B 7/00

(52) U.S. Cl. 30/276

(57) ABSTRACT

A trimmer starter has a cutting-head engaging structure in mechanical communication with an electric motor. Operation of the electric motor causes the cutting-head engaging structure to rotate on its axis, which may drive a cutting head of a trimmer when engaged thereto, thereby forcing the gasoline engine in the trimmer to turn over and eventually start.

### BACKGROUND

Garden implements of the type referred to variously as “weed trimmers” and “string trimmers” comprise a handle or shaft portion and a cutting head at the bottom end of the shaft portion. The cutting head may comprise a spool having one or more short lengths of flexible nylon string, cording, or similar material extending therefrom such that when the cutting head rotates at high speed, the flexible cord may be used to cut small weeds, grass, saplings, and other undesired vegetation. Some models have varying cutting heads, such as a horizontally disposed blade or a vertically disposed blade which are used for lawn edging, bush and brush cutting, etc. Some models have interchangeable or varying cutting heads for multiple purpose use. For the purpose of this disclosure, the term, “trimmer” will refer generally to all such garden implements having a cutting head disposed at the bottom of a handle or shaft whether the cutting surface is formed of nylon, metal, or otherwise.

Commercially available trimmers utilize either an electric motor to rotate the cutting head, or else an internal combustion engine, typically a small 2-stroke type gasoline engine. The electric models have desirable features, such as ease of use, ease of maintenance, and ease of storage. However, they have been limited by either requiring a long electric cord to permit its use at a distance from an available outlet, or else, when powered by a battery, are heavy and underpowered. On the other hand, the gasoline models, while having sufficient power and portability, can be difficult to start.

Starting the internal combustion engine may require priming the engine, setting the choke, and pulling a pull-cord. Starting these engines requires the right amount of priming, and a sufficiently fast pull to generate a spark. The gas/air mixture inside the cylinder must be appropriate, and it sometimes takes several fast pulls or more to get the engine started.

The problem of starting trimmer engines has not yet been adequately addressed by the industry. Trimmers having integrated electric starters have been proposed, but they add too much weight, particularly if they incorporate a battery for providing current to the starter. Furthermore, this solution does not address the problem for existing trimmers that have no integrated starter function.

It would therefore be desirable to provide an inexpensive starter solution for electrically starting any existing gas-powered trimmer without damaging or altering the trimmer and without adding weight to the trimmer.

### SUMMARY OF THE INVENTION

The above-noted problem or problems of the prior art are addressed by a trimmer starter having a cutting-head engaging structure in mechanical communication with an electric motor. Operation of the electric motor causes the cutting-head engaging structure to rotate on its axis, which may drive a cutting head of a trimmer when engaged thereto, thereby forcing the gasoline engine in the trimmer to turn over and eventually start.

### BRIEF DESCRIPTION OF THE DRAWINGS

FIG. 1 shows a trimmer in position for engagement with an exemplary electric starter;

FIG. 2 shows a cross-section schematic view of the exemplary electric starter shown in FIG. 1;

FIG. 3 shows the exemplary electric starter of FIGS. 2 and 3 in plan view; and

FIG. 4 shows an alternative embodiment of the exemplary electric starter of FIG. 2 in a schematic cross-sectional view;

FIG. 5 shows another alternative embodiment of the exemplary electric starter of FIG. 2 in a schematic cross-sectional view.

### DETAILED DESCRIPTION

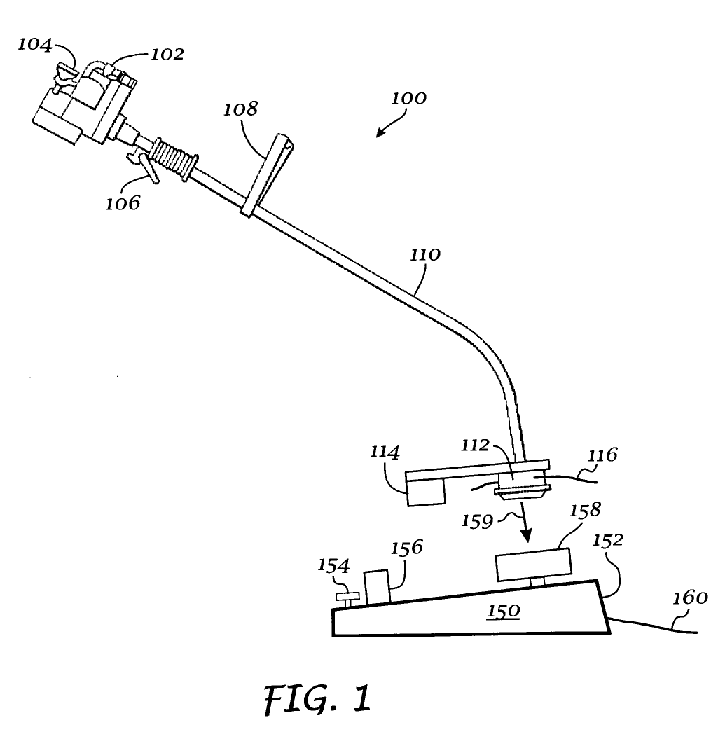

A typical commercially-available trimmer is shown at 100 in FIG. 1. Trimmer 100 has shaft 110 having a power unit 102 at an upper end and a cutting-head 112 at a lower end. Inside shaft 110 is a rotating flexible shaft (not shown) placing power unit 102 in mechanical communication with cutting head 112. Note that some models have a straight shaft, and therefore no requirement that the rotating shaft therein be flexible. Some models may have the power unit sitting directly on top of the cutting head. The location and mechanical connection of the power unit and cutting head is not dispositive of the utility of the electric starter described herein. Power unit 102 may typically comprise, a two-cycle gasoline-powered engine, although the starter disclosed herein is applicable to other types of engines. Power unit 102 includes a flexible pull-cord handle 104 for manually starting the engine, and a throttle control 106. Other controls, such as choke, engine stop, and primer bulb, are not shown for expediency.

In normal operation, power unit 102 is started by priming the engine, setting the choke, holding throttle control 106 in, and pulling on flexible pull-cord handle 104 for turning over the engine. However, the engine may not start right away, necessitating repeated pulls, as described herienabove. Once started, trimmer 100 is operated by holding in the throttle with one hand, grasping handle 108 with another hand and sweeping cutting head 112 so that cords 116 strike unwanted vegetation. Guard 114 helps protect the operator from flying debris and may include a cord-cutting blade for limiting the amount of extension of the nylon cord.

In an alternative and exemplary method of starting, the operator places cutting head 112 into engagement with cutting-head engaging structure 158 of electric starter 150, as shown by arrow 159, and activates electric starter 150 by pressing down on pedal switch 154. Once the engine is started, the operator releases pedal switch 154 and lifts trimmer 100 out of engagement with the cutting-head engaging structure 158.

Pedal 154 switch is biased upward by a spring mechanism (not shown) having sufficient strength to require a predetermined amount of downward force to close the circuit of the starter. The downward force increases the friction between starter 150 and the floor or other surface upon which starter 150 rests sufficiently to prevent torsion forces generated by starter 150 from causing starter from spinning out from under the operator's foot. Friction-enhancing means (not shown), such as rubber feet, spikes, adhesive material, etc., may be used to improve the traction between starter 150 and the surface upon which it rests. Shield 156 helps protect the operator during use.

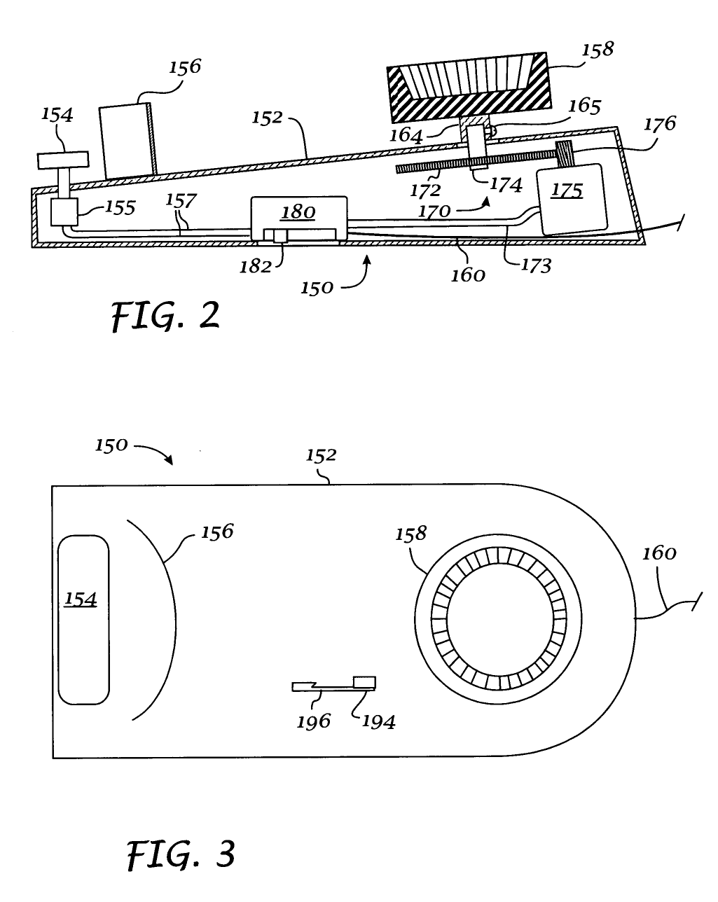

Referring now to FIGS. 2 and 3, the construction of starter 150 will now be described in detail with reference to the schematic cross-section and plan view drawings shown. Starter 150 includes a housing 152 formed from metal, plastic, or other rigid material. Power line 160 extends from outside housing 152 and may be connected to a wall outlet, cigarette lighter socket of a vehicle, external battery, transformer, AC/DC converter, or other power source. In the exemplary embodiment shown in FIG. 2, power line 160 extends to auxiliary housing 180, which may include an AC/DC converter or other power conditioner to meet the current and voltage requirements of motor 175. Auxiliary housing 180 may include a switch 182 for reversing polarity of DC current to motor 175, thereby enabling a reversing function. If motor 175 takes alternating current, e.g., is a single-phase (or split phase) induction motor, then switch 182 is connected to a reversing circuit (not shown) to change the direction of rotation of output shaft 176 of motor 175. Such reversing and motor control circuits are well understood in the art.

Wires 157 extend from auxiliary housing 180 to pedal switch 154. Pedal switch 154 is a momentary-on switch, i.e., it closes an electric circuit while depressed. As mentioned above, Pedal switch 154 includes a biasing spring (not shown) which requires sufficient downward force to close the electric circuit such that adequate friction is developed between starter 150 and the surface upon which it rests, thereby preventing starter 150 from spinning out from under the operator's foot under torque from motor 175.

Wires 173 extend from auxiliary housing 180 to motor 175. While motor 175 and auxiliary housing 180 are shown as separate components, they of course may be combined into a single unit. Alternatively, the circuitry and electrical connections in auxiliary housing 180 may be placed outside of any housing, while switch 182 is provided in any convenient location. By placing switch 180 in a recess in the bottom of housing 152, however, it is less likely to be disturbed once set for the proper rotating direction. Latching means or other type of locking means (not shown) may be utilized to ensure that it is not tampered with.

Electric motor 175 includes an output shaft 176 in mechanical communication via torque transmitting means 170 with cutting head engaging structure 158 such that, as output shaft 176 rotates, so rotates cutting head engaging structure 158. As shown in the exemplary embodiment of FIG. 2, output shaft 176 comprises a pinion gear which engages main gear 172 fixed to shaft 174 which extends outside of housing 152. Shaft 174 is mounted in bearings (not shown) that are fixed in position with respect to housing 152 such that shaft 174 is prohibited from moving except to rotate on its own axis. Electric motor 175 is fixed in position with respect to housing 152 except that it is biased toward main gear 172 to ensure continued engagement with the pinion gear of output shaft 176.

Shaft 174 may have a square, D-shaped, or other non-circular cross-section to prevent relative rotation between it and cutting head engaging structure 158. To lock cutting head engaging structure 158 to shaft 174, a set screw 165 or other locking device may be used. This allows cutting head engaging structure 158 to be removed and replaced with a different cutting head engaging structure. Various cutting head engaging structures may be made to cooperate with existing various cutting heads of various trimmers.

While a torque transmitting means 170 comprises a gear reducer, this may not be necessary. If the electric motor is strong enough to overcome engine resistence and start the motor, then no speed reduction is necessary. In addition, many electric motors are available with included speed reducers and output shaft 176 may be positioned to protrude from housing 152 for direct connection with cutting-head engaging structure 158 as shown in FIG. 5 and discussed below. The person of ordinary skill will therefore envision many possible configurations for torque transmitting means 170 from a simple shaft to various gear configurations, one possible example of which having been shown in FIG. 2, to belt, chain drive, and/or other torque transmitting means.

Cutting head engaging structure 158 is shown as a plastic or rubber cup-shaped receptacle having flutes or ribs arranged along its inner circumferential surface which tapers inwardly such that the inside diameter decreases with depth. Other interior structures, such as nubs or other various-shaped protuberances may be employed. Moreover, the inner surface may include a soft rubber or plastic friction-enhancing material to increase friction between cutting head engaging structure 158 and a cutting head of a trimmer. Note that friction-enhancing devices, including flutes, ribs, nubs, tapering surface, friction-enhancing material, etc., may not be necessary since most trimmers do not require a great deal of torque to start. Rather, these friction-enhancing devices are exemplary and may or may not be necessary. Such friction-enhancing devices as herein described and otherwise known may be implemented selectively by the manufacturer or consumer.

Although a cup-shaped cutting head engaging structure is shown, other structures, such as gripping spring-biased or elastic metal fingers, will of course be possible. As cutting heads are produced in a variety of shapes and sizes, it would be desirable to produce various cutting-head engaging structures to cooperate with existing cutting head designs. Furthermore, a universal cutting-head engaging structure, e.g., having gripping fingers that will grip virtually any existing trimmer cutting head using releasable springs, levers, centripetal force, or other biasing method, can be envisioned. It is also contemplated that a trimmer may be manufactured with specific torque transmitting shape, such as a polygonal shape, ribs, flutes, slots, gear teeth, or any other known torque transmitting shape, for easily and releasably engaging a complimentary torque transmitting structure of starter 150.

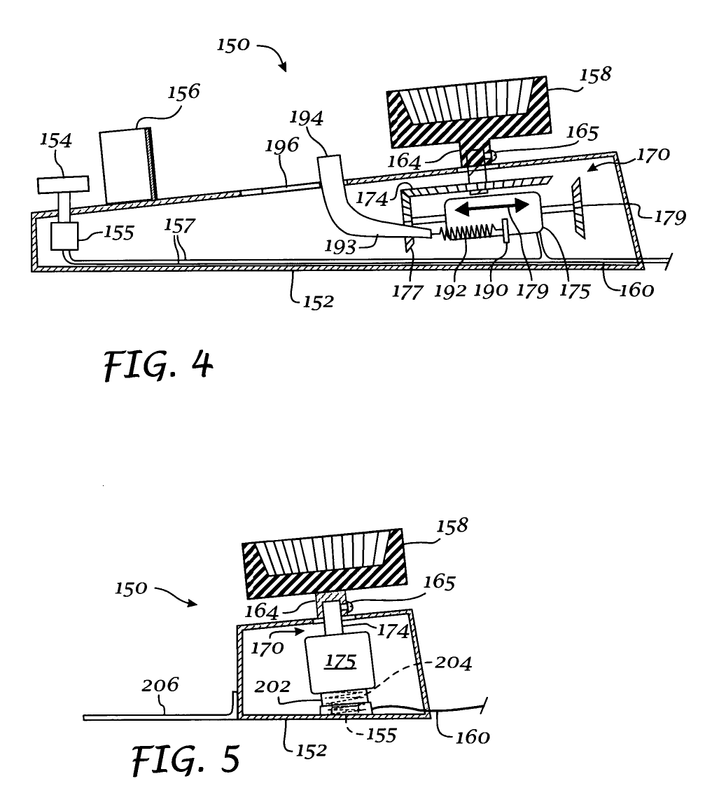

Referring now to FIG. 4, an alternative embodiment is described in which electric motor 175 is a simple universal type motor and the reversing function is achieved mechanically rather than electrically. Motor 175 is mounted on a slide (not shown) such that it may move in one degree of freedom, i.e., it may translate along its axis in the direction of arrow 179. Attached to motor 175 is spring plate 190. One end of spring 192 is fixed to spring plate 190 and an opposite end of spring 192 is attached to lower end 193 of slider 194. Slider 194 is also movable in the direction of arrow 194 and protrudes from housing 152 through slot 196. Slot 196 includes notches as shown in FIG. 3. Thus, when the upper end of slider 194 is resting in a notch, it is prevented from sliding in the opposite direction.

Spring 192 is a tension/compression spring. When motor 175 is in the position shown in FIG. 4, spring 192 is in compression, and therefore biases conical gear 177 against main gear 172. When slider 194 is pulled to a second position at the opposite end of slot 196, the compression in spring 192 is relieved and motor 175 slides into a new position in which conical gear 177 disengages from main gear 172 and conical gear 179 comes into engagement with main gear 172. When slider 194 reaches its new position, spring 192 is placed in tension, thereby biasing conical gear 179 into engagement with main gear 172.

In other respects, the embodiment shown in FIG. 4 is substantially similar to the embodiment shown in FIG. 2. While the reversing function is realized in this exemplary embodiment using a particular arrangement of motor and gears, the person of ordinary skill will understand that there are countless variations and devices that are known to provide such a reversing function, and that the present exemplary embodiment is provided as one solution to the problem of mechanically providing a reversing function.

Furthermore, a reversing function, either a mechanically-operated reversing function or an electrically-operated reversing function, may not be needed, depending on the application. For example, if the electric starter is sold bundled with a trimmer, as described above, then the starter motor need only rotate in a direction consistent with the engine rotation of the trimmer so bundled.

FIG. 5 shows yet another exemplary embodiment which has no reversing function, though of course one may be added if desired. In this embodiment, torque transmitting means 170 simply comprises shaft 174, which is in fact a shaft common to the output shaft of the engine and which extends through housing 152. Switch 155 is housed in motor mount 202 which allows motor 175 limited axial motion and which includes spring 204 to bias motor 175 in an upward direction. Switch 155 is a “momentary on” switch and activates 175 when a downward force is applied on cutting head engaging structure 158, said downward force being transmitted through motor 175 and causing spring 204 to compress, finally closing switch 155 and turning on motor 175. Thus, starter 150 is provided with a pressure-sensing means that senses pressure applied by a trimmer during the starting procedure, and automatically activates the electric motor in response to said pressure-sensing means. Once the engine is started, the operator may simply lift the cutting head out of engagement with cutting head engaging structure 158, thereby opening switch 155 and shutting off motor 175. Legs 206 (only one shown) may be provided to stabilize and reduce likelihood that starter 150 will spin out when motor 175 is turned on.

Note that, while each of the above exemplary embodiments incorporate a switch of some sort, a switch is absolutely necessary, as the device may rely on a remote switch incorporated into the power supply, or may simply turn on when plugged in and shut off when unplugged.

The invention having now been described by way of exemplary embodiments, it is to be understood that the specification is intended to be illustrative and not definitive of the invention, which is to be limited only by the claims appended hereto.

1. An electric starter for a trimmer having a cutting head at its lower end and powered by an internal combustion engine, the starter comprising:
an electric motor; and
a cutting head engaging structure in mechanical communication with said electric motor, said cutting head engaging structure being adapted to engage said cutting head of said trimmer.

2. The electric starter of claim 1 wherein said electric starter further comprises a housing, said cutting head engaging structure is locked to a shaft extending from a housing, said shaft being in mechanical communication with said electric motor.

3. The electric starter of claim 2 wherein said shaft has a non-circular cross section, said cutting head engaging structure having a mating hole into which said shaft extends, thereby preventing relative rotation between said cutting head engaging structure and said shaft.

4. The electric starter of claim 1 wherein said electric motor is part of an electric circuit including a power switch for selectively opening and closing said electric circuit.

5. The electric starter of claim 4 further comprising a housing, wherein said power switch includes a pedal, said pedal extending from said housing such that when said pedal is depressed, said power switch closes and when said pedal is released, said power switch opens.

6. The electric starter of claim 4 further comprising a pressure-sensing means, said pressure-sensing means automatically activating said electric motor in response to pressure being sensed against said cutting head engaging structure.

7. The electric starter of claim 6 wherein said pressure-sensing means comprises a momentary switch and a motor mount, said motor mount allowing said limited movement of said electric motor along its axis, said momentary switch being closed in response to said motor being pushed down in response to a force being applied to said cutting head engaging structure.

7. The electric starter of claim 4 further comprising an electric reversing switch, said electric reversing switch operable to cause said electric motor to reverse directions.

8. The electric starter of claim 7 wherein said electric motor runs on direct current and said reversing switch reverses the polarity the voltage applied to said electric motor.

9. The electric starter of claim 1 further comprising a torque transmitting means placing said electric motor in said mechanical communication with said cutting head engaging structure.

10. The electric starter of claim 9 wherein said torque transmitting means includes a reversing function that selectively and mechanically reverses a direction of rotation of the cutting head gripping structure with respect to a direction of rotation of said electric motor.

11. The electric starter of claim 10 wherein said reversing function includes selectively engaging one of a plurality of gears.

12. The electric starter of claim 9 wherein said torque transmitting means includes a speed reducing function that reduces the turning ratio of the cutting head engaging structure to the electric motor.

13. The electric starter of claim 9 wherein said torque transmitting means includes an output shaft extending from said electric motor, said cutting head engaging structure being fixed directly to said output shaft.

14. A method for starting an engine of a trimmer, the method comprising:
engaging a cutting head at a lower end of said trimmer with a cutting head engaging structure of an electric starter.

15. The method of claim 14 further comprising turning on the electric starter, said turning on the electric starter comprising depressing a pedal extending from said electric starter.

16. The method of claim 14 further comprising turning on the electric starter, said turning on the electric starter comprising applying a downward force to said cutting head engaging structure with said trimmer.
